(19) United States
(12) Patent Application Publication
(10) Pub. No.: US 2013/0059633 A1
(43) Pub. Date: Mar. 7, 2013

(54) SYSTEM, METHOD, AND COMPUTER-READABLE MEDIUM FOR TUTORING WITH VIDEO GAMES AND INTERACTIVE VIDEO

(71) Applicant: Robert Richard Walling, III, Atlanta, GA (US)

(72) Inventor: Robert Richard Walling, III, Atlanta, GA (US)

(21) Appl. No.: 13/594,860

(22) Filed: Aug. 26, 2012

Related U.S. Application Data
(60) Provisional application No. 61/531,045, filed on Sep. 5, 2011.
(60) Provisional application No. 61/637,289, filed on Apr. 24, 2012.

(51) Int. Cl. A63F 13/00; G09B 5/00

(52) U.S. Cl. 463/9; 434/322

(57) ABSTRACT

Disclosed herein is a system, comprising a quiz comprising a set of questions related to a subject, wherein a user submits answers to the questions and the submitted answers are scored with credits; and a video medium, wherein the user can alter the video medium using the credits. Disclosed herein is a method, comprising displaying a set of questions related to a quiz; receiving answers corresponding to the set of questions; scoring the received answers; and issuing credits based on the scored answer, wherein said issued credits may be redeemable within a video medium.

### RELATED APPLICATIONS

This application claims priority to U.S. Provisional Patent Application Ser. No. 61/531,045, filed Sep. 5, 2011, which is herein incorporated by reference. This application is related to U.S. Provisional Patent Application Ser. No. 61/637,289, filed Apr. 24, 2012, which is herein incorporated by reference.

### FIELD OF THE INVENTION

The invention relates generally to tutoring and more specifically to tutoring with video games and interactive video.

### BACKGROUND OF THE INVENTION

Video games and video programs play a prominent role in today's youths' time allocation. In fact, children can neglect their studies in favor of playing video games and watching videos. Educational video games currently exist, but kids do not necessarily enjoy playing these educational games. What is needed is a system, method, and/or computer-readable medium that combines video games and/or videos that are not necessarily educational with educational tutorials.

### SUMMARY OF THE INVENTION

Disclosed herein is a system, comprising a quiz comprising a set of questions related to a subject, wherein a user submits answers to the questions and the submitted answers are scored with credits; and a video medium, wherein the user can alter the video medium using the credits.

Disclosed herein is a method, comprising displaying a set of questions related to a quiz; receiving answers corresponding to the set of questions; scoring the received answers; and issuing credits based on the scored answer, wherein said issued credits may be redeemable within a video medium.

Disclosed herein is a computer-readable medium for use with a computer and having executable instructions for performing a method comprising displaying a set of questions related to a quiz; receiving answers corresponding to the set of questions; scoring the received answers; and issuing credits based on the scored answer, wherein said issued credits may be redeemable within a video medium.

The above described and other features are exemplified by the following figures and detailed description.

### BRIEF DESCRIPTION OF THE DRAWINGS

Referring now to the figures, which are exemplary embodiments, and wherein the like elements are numbered alike:

FIG. 1 is a flow diagram illustrating an exemplary embodiment for administering and scoring a quiz.

FIGS. 2A-2B illustrate an exemplary embodiment of a user interface with a sample question of a quiz.

FIG. 3 illustrates an exemplary embodiment of a user interface with a quiz result summary.

FIG. 4 illustrates an exemplary embodiment of a user interface with a quiz question and answer entry screen.

FIG. 5 illustrates an exemplary embodiment of a user interface with a sample video game screenshot.

FIG. 6 is a flow diagram illustrating an exemplary embodiment for administering a quiz with an interactive video.

FIGS. 7A-7C illustrate exemplary embodiments of sample interactive video screenshots.

FIG. 8 is a flow diagram illustrating an exemplary embodiment for incorporating the results from a current quiz into past statistics.

### DETAILED DESCRIPTION

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. In the following description, numerous specific details are provided, such as examples of user interfaces, screenshots, flow diagrams, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

As used herein, the term “point” refers to a type of currency which users may accumulate or lose through a quiz and may spend or gain in playing video games. In one embodiment, a user may wager points with other users in a video game, interactive video, or quiz.

### Quiz Points as Video Game Currency

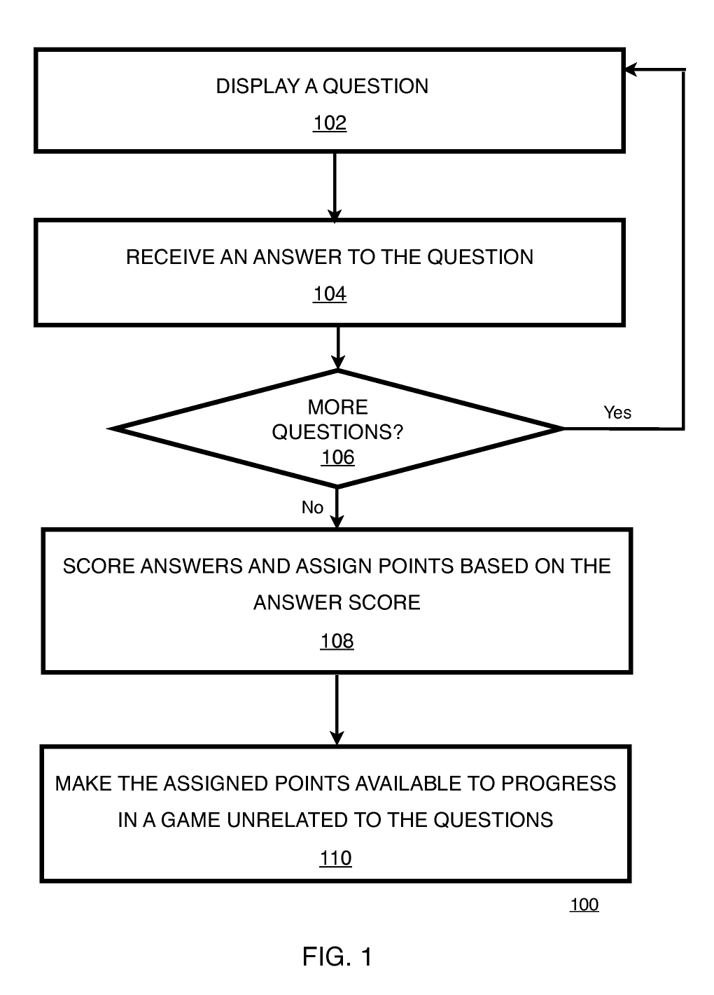

Referring to FIG. 1, a flow diagram of a method 100 for administering and scoring a quiz is illustrated. The quiz may be related to a particular subject, skill level, standardized test, any other logical delimiting category, or any combination of the preceding. The quiz may be created by the user, by another user, or provided by the method. In step 102, a question from a quiz is displayed. In step 104, an answer from a user is received. The method may require that the answer have correct spelling or the method may not require that the answer have correct spelling. Similarly, the answer may or may not require that the answer have correct capitalization. Alternatively, the question may provide multiple choices for answers. Any other known type of question and answer format may be used.

At step 106, the method determines if there are more questions in the quiz. If there are more questions, the next step is step 102. If there are no more questions in the quiz, the next step is step 108. In step 108, the answers are scored and points are assigned. The assigned points are added to the user's previous point total. In step 110, the total assigned points are made accessible in a video game. The points may be used in a variety of ways. For example, in some games, a user has to perform mundane tasks, such as killing sheep, for example, to gain experience and/or money. Instead of performing the mundane tasks, a user may use points gained through quizzes to advance game play, by, for example, exchanging points for money and/or experience.

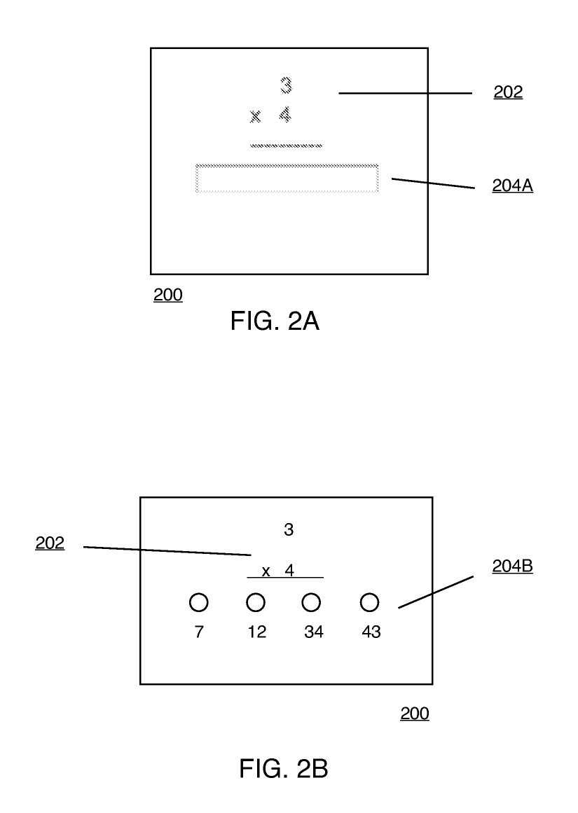

Referring to FIGS. 2A & 2B, a sample user interface 200 displaying a sample quiz question 202 is illustrated. An exemplary question 202 may be from a beginner math quiz or a first grade math quiz, for example. The user interface 200 receives input from the user. The user interface may use any known method of receiving input from a user, such as, for example, allowing a user to enter text into a text box 204A, or allowing a user to select the correct answer from several answers 204B. If the user enters an incorrect answer, the method may immediately notify the user, wait until the end of the quiz to notify the user of all of the incorrect answers, give the user only a score, not notify the user as to his performance at all, or use any other known method of handling an incorrect answer. The method may or may not inform the user of the correct answer. In instances when the user has misspelled an answer that is credited as correct, the method may or may not inform the user of the correct spelling.

In FIG. 2A, the user interface 200 provides a user with the quiz question 202 asking for 3 multiplied by 4 and allows the user to type in an answer in a text box 204A. The method may accept “12”; “twelve”; if misspellings are allowed, a misspelling of twelve; if languages other than English are allowed, a correct answer in another acceptable language; if misspellings are allowed and languages other than English are allowed, a misspelling of a correct answer in another acceptable language; or any other known correct answer. When misspellings are allowed, how to determine an acceptable misspelled word is discussed in more detail below.

FIG. 2B is similar to FIG. 2A except that there is no need to worry about a user entering an unexpected correct answer (such as a misspelled word or a foreign language) because the user must select an answer from the answer choices 204B.

FIGS. 2A & 2B are offered merely as illustrations and are in no way meant to be limiting. Any method of presenting a user with information and receiving input from the user may be used.

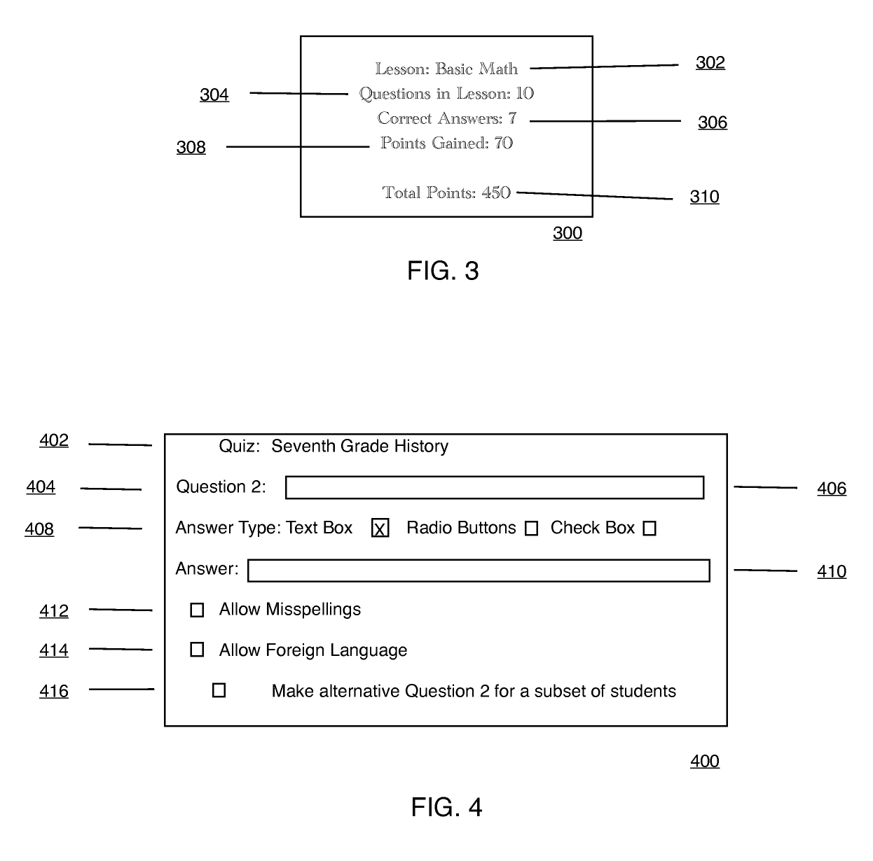

Referring to FIG. 3, a sample user interface 300 for displaying a user's results from a quiz is illustrated. A field 302 may, for example, display the title of the quiz. A field 304 may, for example, display the total number of questions in the quiz. A field 306 may, for example, display the total number of questions the user answered correctly. A field 308 may, for example, display a number of points the user received from the quiz. A field 310 may, for example, display a new total of points for the user.

In FIG. 3, the user interface 300 shows that the title of the quiz is “Basic Math” 302, the number of questions in the quiz is 10. The number of questions the user got correct is 7 306, and the user gained 70 points 308. Before the user took the quiz, the user had 380 points and now the user has 450 points 310.

FIG. 3 is offered merely as an illustration and is in no way meant to be limiting. Any method of conveying performance feedback to a user may be used. In one embodiment, no method of conveying performance feedback is used at all.

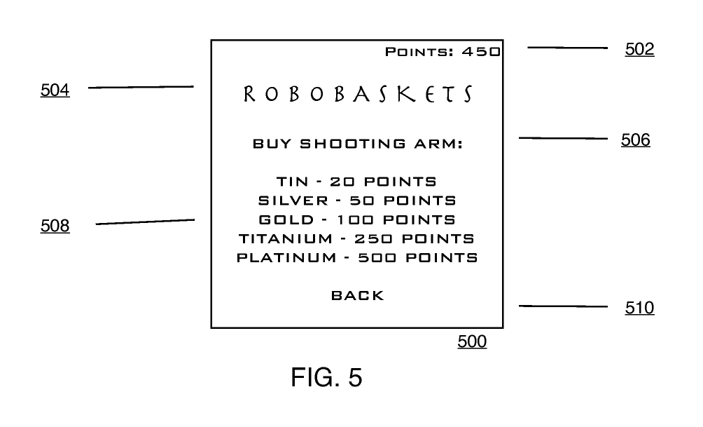

Referring to FIG. 4, a user interface 400 for allowing a user to enter questions which can be used to make up a quiz. A field 402 may, for example, display the title of the current quiz. For instance, if the user is entering questions in a quiz for a seventh grade history class, the field 402 may contain “Seventh Grade History.” A field 404 may, for example, display the current question count on the current quiz. For instance, if the user is entering the second question of a quiz, the field 404 may contain “Question 2”. A field 406 may, for example, be used to accept a question from the user. The field 406, may be a text box or any other known method for receiving input from the user. A field 408 may, for example, be used to keep track of what type of answer the question will receive. For instance, if the user wants those people taking the test to enter their answer in a text box, the user may select “text box”, or a similar response, for the field 408. If the user wants those people taking the test to select the correct answer from a list of possible answers, the user may select “radio buttons”, or a similar response, for the field 408. The user may select any other appropriate selection for the field 408.

A field 410 may, for example, receive the correct answers for the question. If the user decides to allow people taking the quiz to select the correct answer(s) from a choice of answers, then the user may simply enter the answer choices. Alternatively, if the user has decided to allow people taking the quiz to type an answer, then the user may need to determine if the quiz will accept answers that are misspelled and/or in a foreign language.

A field 412 may, for example, allow a user to select whether the quiz will accept misspelled words. There are several ways that a user may indicate which particular misspelled word or words will be scored as correct. For instance, the user may create a list of acceptable alternate spellings. For a question, the answer may be “Mississippi”. The user may create a misspelled word list with “Mississipi”, “Missisippi”, and “Mississippy”, for example. In addition or alternatively, the user may create a set of rules for the misspelled word. For “Mississippi”, the user may, for example, make the rules as follows: 1) starts with ‘M’; 2) followed by one of ‘i’, ‘e’, ‘y’; 3) followed by one or more ‘s’; 4) followed by one of ‘i’, ‘e’, ‘y’; 5) followed by one or more ‘s’; 6) followed by one of ‘i’, ‘e’, ‘y’; 7) followed by one or more ‘p’; and 8) followed by one of ‘i’, ‘e’, ‘y’. If all of the rules are met, the quiz may credit an incorrectly spelled word as correct. In addition or alternatively, the user may indicate that a phonetic spelling should be credited as correct. A phonetic spelling may be a spelling according to the Soundex method, a variation on the Soundex method, or any other phonetic spelling method. In addition or alternatively, a misspelling may be credited as partially correct, receiving a fraction of the available points for the question.

A field 414 may, for example, allow a user to select whether the quiz will accept foreign languages. The user may choose which foreign languages are acceptable or may simply allow all that the method recognizes.

A field 416 may, for example, allow a user to make a different question and/or answer choices for different quiz takers. For instance, a question in a particular quiz may be suitable for a regular class, too easy for an advanced class, and/or too hard for a remedial class. The user may select the field 416 to indicate that the user is going to enter a different, harder “Question 2” for the students in honors seventh grade history. Additionally, the user may keep the question the same, but offer different, harder answer choices.

In one embodiment, a user may indicate how much time will be allocated to each question. In such an embodiment, the user may alter the time allocated on a particular question for a particular quiz taker or subset of quiz takers. In addition or alternatively, the user may indicate how many points will be allocated to each question. In such an embodiment, the user may alter the points available for a particular question for a particular quiz taker or subset of quiz takers. In addition or alternatively, the user may allocate a certain number of points and the points awarded to a quiz taker may decrease from the allocated number as the amount of time it takes the quiz taker to answer the question increases. In addition or alternatively, the user may allocate different point numbers for different misspellings.

FIG. 4 is offered merely as an illustration and is in no way meant to be limiting. In an exemplary embodiment, a user could upload, scan or otherwise input notes, outlines or other data in a format that the method expects and generate quiz questions and answers with the data. Any method of allowing a user to enter quiz questions and answers may be used.

Users may be organized into, for example, groups or classes. Once a user makes a quiz, the quiz may be made available to selected quiz takers, quiz takers belonging to certain groups or classes, everyone, or any other subset of quiz takers.

After a user makes a new quiz and designates a subset of quiz takers to which the quiz is available, information of the new quiz may, for example, be sent to the subset of quiz takers via electronic mail (e-mail), instant message, text message, or any other known method of sending information.

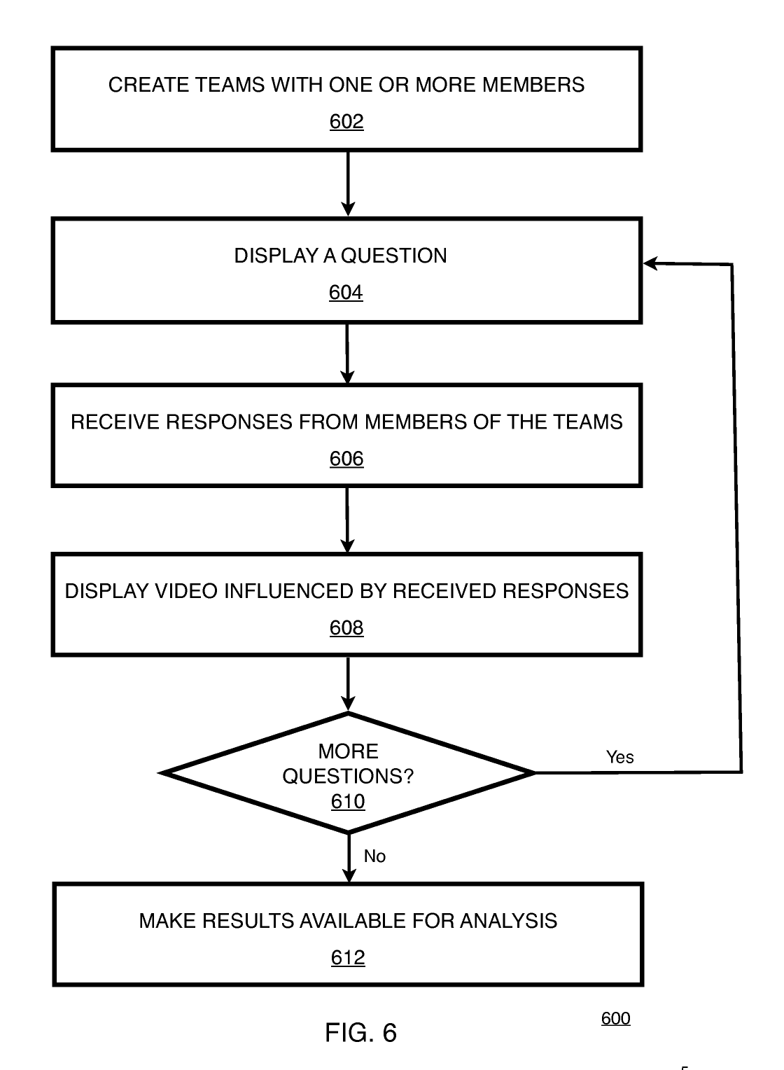

Referring to FIG. 5, an exemplary video game screen 500 is illustrated. A field 502 may, for example, display a user's total points. A field 504 may, for example, display a title of a currently selected video game. A field 506 may, for example, display an item within the currently selected video game that the user wants to upgrade with points earned by taking quizzes. In one embodiment, the field 506 may, for example, be a list of items with a count representing how many items the user has. A field 508 may, for example, display upgrade options for the item which the user wants to upgrade. In one embodiment, the field 508 may, for example, simply display items within the currently selected video game which the user may purchase. If the user decides to upgrade or purchase an item, the user may do so by forfeiting the specified number of points and the user's total points may be deducted by the specified number of points. A field 510 may, for example, contain a button that allows the user to leave the current screen 500.

In FIG. 5, a user is on a screen 500 for a game titled ROBOBASKETS 504. The user has 450 points 502 and has chosen to upgrade one of the user's robots' shooting arms 506. The more the user spends on the robot's shooting arm, the higher quality the arm is 508, though the number of points an upgrade or item cost does not necessarily have to coincide with how useful the upgrade or item is in the game. If the user decides to leave the screen 500 without upgrading the robot's shooting arm, the user can press “BACK” 510.

In one embodiment, a video game, interactive video, or quiz may contain advertising. For instance, in a basketball video game, companies may bid to place their corporate logos on the court in the game or in other places in the game. Any other known method of embedding advertisements in video games, interactive videos, or quizzes may be used.

FIG. 5 is offered merely as an illustration and is in no way meant to be limiting. Any method of allowing a user to exchange points earned in a quiz for upgrades, items, video game cheats, or any other video game enhancement may be used.

### Interactive Video

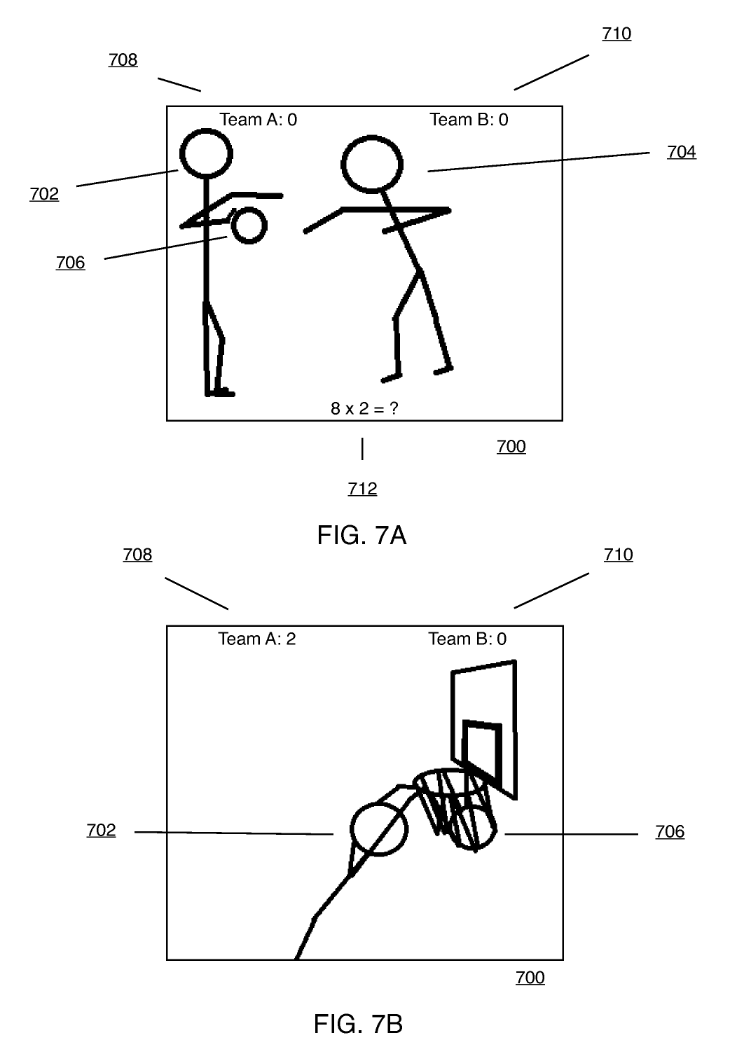

Referring to FIG. 6, a flow diagram of a method 600 for administering quiz questions in conjunction with an interactive video is illustrated. In step 602, a group of users may be divided into two or more teams. If only one team has one or more user members, then one or more computer controlled teams may be created. In one embodiment, each user may comprise their own team.

In step 604, a question from a current quiz is displayed. In step 606, the method receives a response from one or more members of one or more teams. The method may have a timer that forces users to enter their answers before the timer expires. If the method includes a timer and the timer expires before any users enter a response, then the method may move to step 608 without receiving a response from any users. In step 608, a video currently playing is influenced by the received responses.

The degree of correctness, response time, any other appropriate response standard, or any combination of the preceding may be considered in influencing the interactive video. A particular subset of users may have their responses weighted differently than other users. For instance, students in a regular class may have their responses weighted at 1.0; students in an honors class may have their responses weighted at 0.5; and students in a remedial class may have their responses weighted at 1.5. In such a circumstance, an honors student may have to answer a question correctly three times as fast as a remedial student and/or answer three correct questions for every one correct question a remedial student gets correct in order to have the same influence over the video as a remedial student.

In one embodiment, the method may consider the first answer, instead of aggregating answers in some fashion as described above. For instance, the method may have two teams, Team A and Team B, and, for the sake of simplicity, a video may be approaching a fork with two possibilities: a pro Team A scene and a pro Team B scene. A player from Team A may be the first player to enter a response. If the responding Team A player's response is correct, then the pro Team A scene may be displayed. Otherwise, the pro Team B scene may be displayed. In one embodiment, the method may consider which team has the first player to enter a correct response.

In one embodiment, the users all take the quiz at the same time in the same location. For instance, students may take the quiz on networked computers in a computer lab or on their personal laptops connected to the Internet. In such an embodiment, the questions and video shown on each computer may be the same throughout the video. In addition or alternatively, the quiz may progress through the questions at the same time, but individual students may receive different quiz questions from one another. In other words, for example, every student's quiz question number 2 may not be the same.

In one embodiment, the users begin the test at the same time, but do not necessarily start each question at the same time. In one embodiment, a user is allowed to progress to successive questions as soon as the user gives a response to the current question. In addition or alternatively, users may have a different amount of time for each question. In other words, for example, one student may have 30 seconds for the second question while another student has 45 seconds.

In one embodiment, users do not necessarily begin a quiz at the same time. A user's responses may be saved and later used as a “shadow opponent” for other users. In addition or alternatively, one or more user responses may be saved and the interactive video may be influenced by the saved responses; so that the method may not need to receive user input while the video is displaying.

In step 610, the method checks for more questions. If there are more questions, the method proceeds to step 604. If there are no more questions, then the method moves to step 612, where the method makes question response results available for analysis. For instance, a teacher may want to analyze a class's results after the class completes an interactive video/quiz. The teacher may analyze issues the majority of the class is having, as well as what issues particular students are having.

Any of the steps may be performed in any order. In particular, step 610 may occur directly after step 606, so that all of the questions are answered before the video is influenced by any responses.

In one embodiment, all of the quiz questions are answered and then each user is assigned a weigh based on their quiz results. During the video, the users are allowed to vote on how the video should precede, each user's video response may be weighted by the quiz result weight.

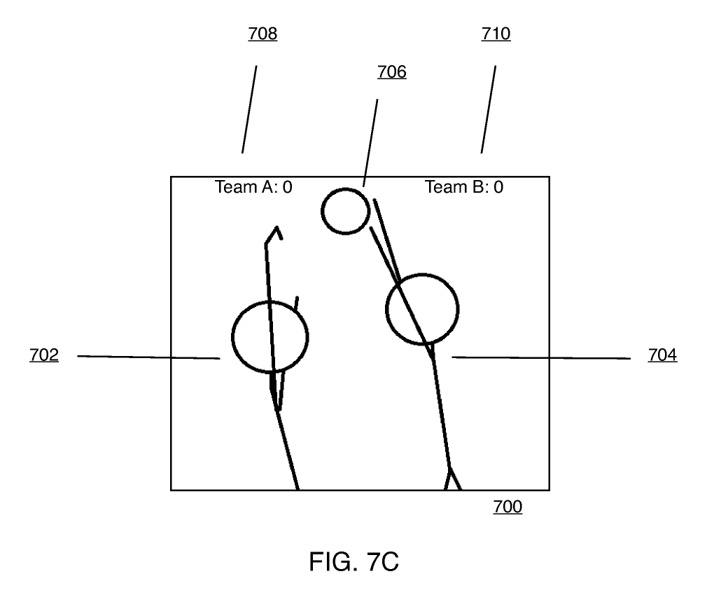

Referring to FIGS. 7A-7C, a screen 700 showing an exemplary interactive video is illustrated. In FIGS. 7A-7C, like elements are similarly numbered. In FIGS. 7A-7C, the users are divided into two teams: Team A and Team B. Team A is represented by stick figure 702 and has the score represented in field 708. Team B is represented by stick figure 704 and has the score represented in field 710. In FIG. 7A, Team A's stick figure 702 is holding a basketball 706 and Team B's stick figure 704 is playing defense. In FIG. 7A, field 712 displays the question “8×2=?”.

FIG. 7B illustrates a possible video scene if Team A's players are more successful in answering the question in field 712 than Team B's players. In this scene 700, Team A's stick figure 702 scores a goal and Team A's score is so reflected in field 708.

FIG. 7C illustrates a possible scene if Team B's players are more successful in answering the question in field 712 than Team A's players. In this scene 700, Team B's stick figure blocks Team A's stick figure's 702 shot and gains control of the basketball 706. In this particular scene 700, neither Team A's score 708 nor Team B's score 710 changes.

Which scene a video shows may vary on more factors than simply which team had the best results. For instance, the discrepancy between the teams may determine which scene is shown. If, for example, the players on Team A do much better in answering the question in field 712 than the players on Team B, then Team A's stick figure 702 may dunk the basketball 706. However, if the margin between the results of the two teams is closer, then Team A's stick figure 702 may simply try a jump shot. How many players on a team answered the question in field 712 and how long it took for the players to answer the question may also factor in to which video is displayed.

FIGS. 7A-7C are offered merely as illustrations and are in no way meant to be limiting. Any interactive video influenced by the responses of one or more users of one or more teams may be used.

### Tracking Quiz Results

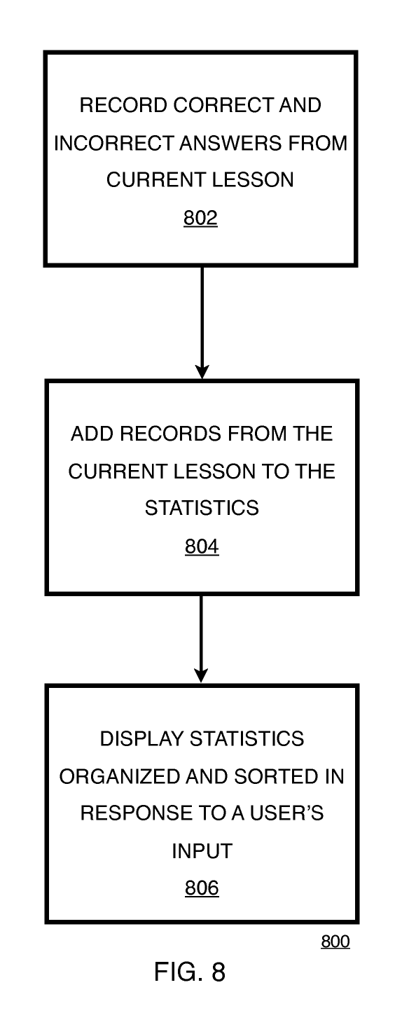

Referring to FIG. 8, a flow diagram of a method 800 for collecting and displaying quiz results is illustrated. In step 802, the method may track user answers. The method may keep track of the exact answer a user entered or may simply tally incorrect and correct answers. The method may track an individual user's performance on an individual quiz, an individual user's performance on multiple quizzes, a certain subset of users' performance on an individual quiz, a certain subset of users' performance on multiple quizzes or any logical combination of user performance and quiz performance.

In step 804, the results from a current quiz may be added to the stored results. In step 806, the quiz results may be organized and displayed in response to a user's input. The results may be sorted by, for example, a quiz taker, a quiz subject, a quiz skill level, a subset of quiz takers, such as a group or class, or any other logical combination.

Once a quiz taker completes a quiz, the results or news of the results, may be sent to an interested party, such as the quiz taker's parents or teachers, for example. The results or news of the results may, for example, be sent to the interested parties via electronic mail (e-mail), instant message, text message, or any other known method of sending information.

The underlined headings above are intended to aid a reader in reading the specification and are not intended to be limiting. Certain aspects of the present invention are not limited to a particular heading. For instance, even though there is an “Interactive Video” heading, aspects of interactive video are described in other portions of the specification.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus, including smart phones and other mobile devices, adapted for carrying out the methods described herein is suited. A typical combination of hardware and software with a computer system with a computer program that, when being loaded and executed, controls the computer system such that it carries out the methods described herein. Another typical combination may be a general-purpose computer system with a computer program that, when being loaded and executed, controls the computer system such that it carries out the methods described herein. Another typical combination may be both a mobile communication device with a computer system with a computer program that, when being loaded and executed, controls the computer system such that it carriers out the methods described herein and a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A system, comprising:
a quiz comprising a set of questions related to a subject, wherein a user submits answers to the questions and the submitted answers are scored with credits; and
a video medium, wherein the user can alter the video medium using the credits.

2. The system of claim 1, wherein the video medium is a video game.

3. The system of claim 1, wherein the video medium is an interactive video.

4. The system of claim 1, further comprising;
a user account comprising:
quiz results related to the user; and
video medium related to the user.

5. The system of claim 4, wherein the user account further comprises one or more user supplied quizzes.

6. The system of claim 5, wherein the user can allow other users to take the one or more user supplied quizzes.

7. The system of claim 4, wherein statistics related to the quiz results of the user is available.

8. The system of claim 4, wherein a student has an account that relates the teachers and quizzes with the classes the student takes.

9. The system of claim 4, wherein a teacher has an account that relates the quizzes and students with the classes the teacher teaches.

10. The system of claim 4, wherein a parent has an account that allows the parent to see statistics representing the quizzes that the students related to the parent took.

11. A method, comprising:
displaying a set of questions related to a quiz;
receiving answers corresponding to the set of questions;
scoring the received answers; and
issuing credits based on the scored answer, wherein said issued credits may be redeemable within a video medium.

12. The method of claim 11, wherein the video medium is a video game.

13. The method of claim 11, wherein the video medium is an interactive video.

14. The method of claim 11, further comprising:
relating a user to the received answers.

15. The method of claim 11, further comprising:
relating a user to the issued credits.

16. A computer-readable medium for use with a computer and having executable instructions for performing a method comprising:
displaying a set of questions related to a quiz;
receiving answers corresponding to the set of questions;
scoring the received answers; and
issuing credits based on the scored answer, wherein said issued credits may be redeemable within a video medium.

17. The computer-readable medium of claim 16, wherein the video medium is a video game.

18. The computer-readable medium of claim 16, wherein the video medium is an interactive video.

19. The computer-readable medium of claim 16, further comprising:
relating a user to the received answers.

20. The computer-readable medium of claim 16, further comprising:
relating a user to the issued credits.
